(19) United States
(12) Patent Application Publication
(10) Pub. No.: US 2007/0106685 A1
(43) Pub. Date: May 10, 2007

(54) Method and apparatus for updating speech recognition databases and reindexing audio and video content using the same

(75) Inventors: Henry Houh, Lexington, MA (US); Jeffrey Nathan Stern, Belmont, MA (US); Nina Zinovieva, Lowell, MA (US); Marie Meteer, Arlington, MA (US)

Correspondence Address: PROSKAUER ROSE LLP, ONE INTERNATIONAL PLACE 14TH FL, BOSTON, MA, 02110, US

(73) Assignee: Podzinger Corp., Cambridge, MA (US)

(21) Appl. No.: 11/522,645

(22) Filed: Sep. 18, 2006

Related U.S. Application Data
(63) Continuation-in-part of application No. 11/395,732, filed on Mar. 31, 2006.
(60) Provisional application No. 60/736,124, filed on Nov. 9, 2005.

(51) Int. Cl. G06F 7/00

(52) U.S. Cl. 707/102

(57) ABSTRACT

A method and apparatus for reindexing media content for search applications that includes steps and structure for providing a speech recognition database that include entries defining acoustical representations for a plurality of words; providing a searchable database containing a plurality of metadata documents descriptive of a plurality of media resources, each of the plurality of metadata documents including a sequence of speech recognized text indexed using the speech recognition database; updating the speech recognition database with at least one word candidate; and reindexing the sequence of speech recognized text for a subset of the plurality of metadata documents using the updated speech recognition database.

### RELATED APPLICATIONS

This application is a continuation-in-part of U.S. patent application Ser. No. 11/395,732, filed on Mar. 31, 2006, which claims the benefit of U.S. Provisional Application No. 60/736,124, filed on Nov. 9, 2005. The entire teachings of the above applications are incorporated herein by reference.

### FIELD OF THE INVENTION

Aspects of the invention relate to methods and apparatus for generating and using enhanced metadata in search-driven applications.

### BACKGROUND OF THE INVENTION

As the World Wide Web has emerged as a major research tool across all fields of study, the concept of metadata has become a crucial topic. Metadata, which can be broadly defined as “data about data,” refers to the searchable definitions used to locate information. This issue is particularly relevant to searches on the Web, where metatags may determine the ease with which a particular Web site is located by searchers. Metadata that are embedded with content is called embedded metadata. A data repository typically stores the metadata detached from the data.

Results obtained from search engine queries are limited to metadata information stored in a data repository, referred to as an index. With respect to media files or streams, the metadata information that describes the audio content or the video content is typically limited to information provided by the content publisher. For example, the metadata information associated with audio/video podcasts generally consists of a URL link to the podcast, title, and a brief summary of its content. If this limited information fails to satisfy a search query, the search engine is not likely to provide the corresponding audio/video podcast as a search result even if the actual content of the audio/video podcast satisfies the query.

### SUMMARY OF THE INVENTION

According to one aspect, the invention features an automated method and apparatus for generating metadata enhanced for audio, video or both (“audio/video”) search-driven applications. The apparatus includes a media indexer that obtains an media file or stream (“media file/stream”), applies one or more automated media processing techniques to the media file/stream, combines the results of the media processing into metadata enhanced for audio/video search, and stores the enhanced metadata in a searchable index or other data repository. The media file/stream can be an audio/video podcast, for example. By generating or otherwise obtaining such enhanced metadata that identifies content segments and corresponding timing information from the underlying media content, a number of for audio/video search-driven applications can be implemented as described herein. The term “media” as referred to herein includes audio, video or both.

According to another aspect, the invention features a computerized method and apparatus for generating search snippets that enable user-directed navigation of the underlying audio/video content. In order to generate a search snippet, metadata is obtained that is associated with discrete media content that satisfies a search query. The metadata identifies a number of content segments and corresponding timing information derived from the underlying media content using one or more automated media processing techniques. Using the timing information identified in the metadata, a search result or “snippet” can be generated that enables a user to arbitrarily select and commence playback of the underlying media content at any of the individual content segments. The method further includes downloading the search result to a client for presentation, further processing or storage.

According to one embodiment, the computerized method and apparatus includes obtaining metadata associated with the discrete media content that satisfies the search query such that the corresponding timing information includes offsets corresponding to each of the content segments within the discrete media content. The obtained metadata further includes a transcription for each of the content segments. A search result is generated that includes transcriptions of one or more of the content segments identified in the metadata with each of the transcriptions are mapped to an offset of a corresponding content segment. The search result is adapted to enable the user to arbitrarily select any of the one or more content segments for playback through user selection of one of the transcriptions provided in the search result and to cause playback of the discrete media content at an offset of a corresponding content segment mapped to the selected one of the transcriptions. The transcription for each of the content segments can be derived from the discrete media content using one or more automated media processing techniques or obtained from closed caption data associated with the discrete media content.

The search result can also be generated to further include a user actuated display element that uses the timing information to enable the user to navigate from an offset of one content segment to an offset of another content segment within the discrete media content in response to user actuation of the element.

The metadata can associate a confidence level with the transcription for each of the identified content segments. In such embodiments, the search result that includes transcriptions of one or more of the content segments identified in the metadata can be generated, such that each transcription having a confidence level that fails to satisfy a predefined threshold is displayed with one or more predefined symbols.

The metadata can associate a confidence level with the transcription for each of the identified content segments. In such embodiments, the search result can be ranked based on a confidence level associated with the corresponding content segment.

According to another embodiment, the computerized method and apparatus includes generating the search result to include a user actuated display element that uses the timing information to enables a user to navigate from an offset of one content segment to an offset of another content segment within the discrete media content in response to user actuation of the element. In such embodiments, metadata associated with the discrete media content that satisfies the search query can be obtained, such that the corresponding timing information includes offsets corresponding to each of the content segments within the discrete media content. The user actuated display element is adapted to respond to user actuation of the element by causing playback of the discrete media content commencing at one of the content segments having an offset that is prior to or subsequent to the offset of a content segment in presently playback.

In either embodiment, one or more of the content segments identified in the metadata can include word segments, audio speech segments, video segments, non-speech audio segments, or marker segments. For example, one or more of the content segments identified in the metadata can include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity. The one or more of the content segments identified in the metadata can also include video of individual scenes, watermarks, recognized objects, recognized faces, overlay text or video separated by markers embedded within the media content.

According to another aspect, the invention features a computerized method and apparatus for presenting search snippets that enable user-directed navigation of the underlying audio/video content. In particular embodiments, a search result is presented that enables a user to arbitrarily select and commence playback of the discrete media content at any of the content segments of the discrete media content using timing offsets derived from the discrete media content using one or more automated media processing techniques.

According to one embodiment, the search result is presented including transcriptions of one or more of the content segments of the discrete media content, each of the transcriptions being mapped to a timing offset of a corresponding content segment. A user selection is received of one of the transcriptions presented in the search result. In response, playback of the discrete media content is caused at a timing offset of the corresponding content segment mapped to the selected one of the transcriptions. Each of the transcriptions can be derived from the discrete media content using one or more automated media processing techniques or obtained from closed caption data associated with the discrete media content.

Each of the transcriptions can be associated with a confidence level. In such embodiment, the search result can be presented including the transcriptions of the one or more of the content segments of the discrete media content, such that any transcription that is associated with a confidence level that fails to satisfy a predefined threshold is displayed with one or more predefined symbols. The search result can also be presented to further include a user actuated display element that enables the user to navigate from an offset of one content segment to another content segment within the discrete media content in response to user actuation of the element.

According to another embodiment, the search result is presented including a user actuated display element that enables the user to navigate from an offset of one content segment to another content segment within the discrete media content in response to user actuation of the element. In such embodiments, timing offsets corresponding to each of the content segments within the discrete media content are obtained. In response to an indication of user actuation of the display element, a playback offset that is associated with the discrete media content in playback is determined. The playback offset is then compared with the timing offsets corresponding to each of the content segments to determine which of the content segments is presently in playback. Once the content segment is determined, playback of the discrete media content is caused to continue at an offset that is prior to or subsequent to the offset of the content segment presently in playback.

In either embodiment, one or more of the content segments identified in the metadata can include word segments, audio speech segments, video segments, non-speech audio segments, or marker segments. For example, one or more of the content segments identified in the metadata can include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity. The one or more of the content segments identified in the metadata can also include video of individual scenes, watermarks, recognized objects, recognized faces, overlay text or video separated by markers embedded within the media content.

According to another aspect, the invention features a computerized method and apparatus for reindexing media content for search applications that comprises the steps of, or structure for, providing a speech recognition database that include entries defining acoustical representations for a plurality of words; providing a searchable database containing a plurality of metadata documents descriptive of a plurality of media resources, each of the plurality of metadata documents including a sequence of speech recognized text indexed using the speech recognition database; updating the speech recognition database with at least one word candidate; and reindexing the sequence of speech recognized text for a subset of the plurality of metadata documents using the updated speech recognition database. Each of the acoustical representations can be a string of phonemes. The plurality of words can include individual words or multiple word strings. The plurality of media resources can include audio or video resources, such as audio or video podcasts, for example.

Reindexing the sequence of speech recognized text can include reindexing all or less than all of the speech recognized text. The subset of reindexed metadata documents can include metadata documents having a sequence of speech recognized text generated before the speech recognition database was updated with the at least one word candidate. The subset of reindexed metadata documents can include metadata documents having a sequence of speech recognized text generated before the at least one word candidate was obtained from the one or more sources.

According to particular embodiments, the computerized method and apparatus can further include the steps of, or structure for, scheduling a media resource for reindexing using the updated speech recognition database with different priorities. For example, a media resource can be scheduled for reindexing with a high priority if the content of the media resource and the at least one word candidate are associated with a common category. The media resource can be scheduled for reindexing with a low priority if the content of the media resource and the at least one word candidate are associated with different categories. The media resource can be scheduled for partial reindexing using the updated speech recognition database if the metadata document corresponding to the media resource contains one or more phonetically similar words to the at least one word candidate added to the speech recognition database. Where the metadata document includes sequence of phonemes derived from a media resource, the corresponding media resource can be scheduled for partial reindexing using the updated speech recognition database if the metadata document contains at least one phonetically similar region to the constituent phonemes of the at least one word candidate added to the speech recognition database.

According to particular embodiments, the computerized method and apparatus can further include the steps of, or structure for, updating the speech recognition database with at least one word includes adding an entry to the speech recognition database that maps the at least one word candidate to an acoustical representation. For example, the entry can be added to a dictionary of the speech recognition database. The entry can be added to a language model of the speech recognition database.

According to particular embodiments, the computerized method and apparatus can further include the steps of, or structure for, updating the speech recognition database with at least one word by adding a rule to a post-processing rules database, the rule defining criteria for replacing one or more words in a sequence of speech recognized text with the at least one word candidate during a post processing step.

According to particular embodiments, the computerized method and apparatus can further include the steps of, or structure for, obtaining metadata descriptive of a media resource, the metadata comprising a first address to a first web site that provides access to the media resource; accessing the first web site using the first address to obtain data from the web site; and selecting the at least one word candidate from the text of words collected or derived from the data obtained from the first web site; and updating the speech recognition database with the at least one word candidate. The at least one word candidate can include one or more frequently occurring words from the data obtained from the first web site. The computerized method and apparatus can further include the steps of, or structure for, accessing the first web site to identify one or more related web sites that are linked to or referenced by the first web site; obtaining web page data from the one or more related web sites; selecting the at least one word candidate from the text of words collected or derived from the web page data obtained from the related web sites; and updating the speech recognition database with the at least one word candidate.

According to particular embodiments, the computerized method and apparatus can further include the steps of, or structure for, obtaining metadata descriptive of a media resource, the metadata including descriptive text of the media resource; selecting the at least one word candidate from the descriptive text of the metadata; and updating the speech recognition database with the at least one word candidate. The descriptive text of the metadata can include a title, description or a link to the media resource. The descriptive text of the metadata can also include information from a web page describing the media resource.

According to particular embodiments, the computerized method and apparatus can further include the steps of, or structure for, obtaining web page data from a selected set of web sites; selecting the at least one word candidate from the text of words collected or derived from the web page data obtained from the related web sites; and updating the speech recognition database with the at least one word candidate. The at least one word candidate can include one or more frequently occurring words from the data obtained from the selected set of web sites.

According to particular embodiments, the computerized method and apparatus can further include the steps of, or structure for, tracking a plurality of search requests received by a search engine, each search request including one or more search query terms; and selecting the at least one word candidate from the one or more search query terms. The at least one word candidate can include one or more search terms comprising a set of topmost requested search terms.

According to particular embodiments, the computerized method and apparatus can further include the steps of, or structure for, generating an acoustical representation associated with a confidence score for the at least one word candidate; and updating the speech recognition database with the at least one word candidate having a confidence score that satisfies a predetermined threshold. The computerized method and apparatus can further include the steps of, or structure for, excluding the at least one word candidate having a confidence score that fails to satisfy a predetermined threshold from the speech recognition database.

### BRIEF DESCRIPTIONS OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a diagram illustrating an apparatus and method for generating metadata enhanced for audio/video search-driven applications.

FIG. 1B is a diagram illustrating an example of a media indexer.

FIG. 2 is a diagram illustrating an example of metadata enhanced for audio/video search-driven applications.

FIG. 3 is a diagram illustrating an example of a search snippet that enables user-directed navigation of underlying media content.

FIGS. 4 and 5 are diagrams illustrating a computerized method and apparatus for generating search snippets that enable user navigation of the underlying media content.

FIG. 6A is a diagram illustrating another example of a search snippet that enables user navigation of the underlying media content.

FIGS. 6B and 6C are diagrams illustrating a method for navigating media content using the search snippet of FIG. 6A.

FIG. 7 is a diagram illustrating a back-end multimedia search system including a speech recognition database.

FIGS. 8A and 8B illustrate a system and method for updating a speech recognition database.

FIGS. 9A-9D are flow diagrams illustrating methods for obtaining word candidates from one or more sources.

FIGS. 10A and 10B illustrate an apparatus and method, respectively, for scheduling media content for reindexing using an updated speech recognition database.

### DETAILED DESCRIPTION

Generation of Enhanced Metadata for Audio/Video

The invention features an automated method and apparatus for generating metadata enhanced for audio/video search-driven applications. The apparatus includes a media indexer that obtains an media file/stream (e.g., audio/video podcasts), applies one or more automated media processing techniques to the media file/stream, combines the results of the media processing into metadata enhanced for audio/video search, and stores the enhanced metadata in a searchable index or other data repository.

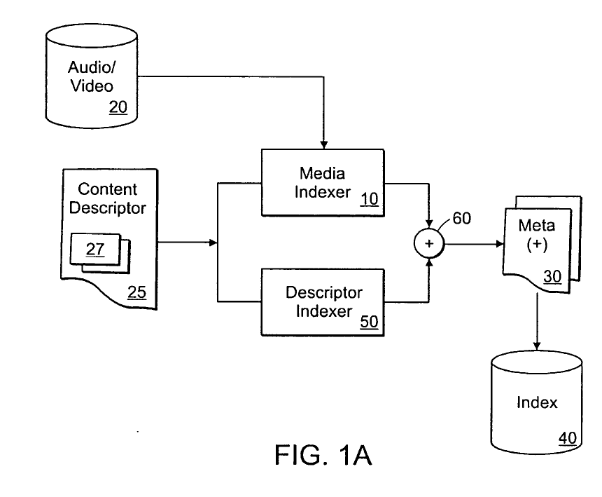

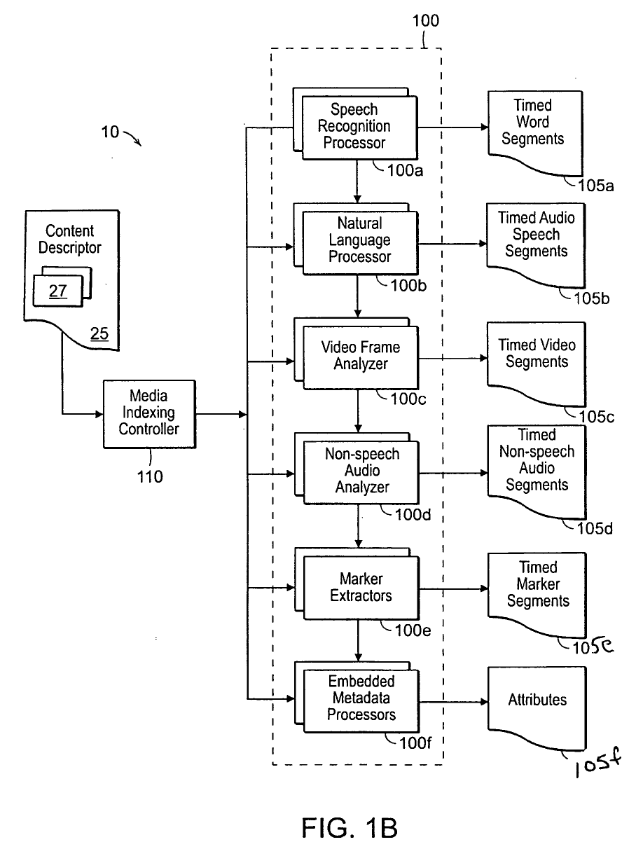

FIG. 1A is a diagram illustrating an apparatus and method for generating metadata enhanced for audio/video search-driven applications. As shown, the media indexer 10 cooperates with a descriptor indexer 50 to generate the enhanced metadata 30. A content descriptor 25 is received and processed by both the media indexer 10 and the descriptor indexer 50. For example, if the content descriptor 25 is a Really Simple Syndication (RSS) document, the metadata 27 corresponding to one or more audio/video podcasts includes a title, summary, and location (e.g., URL link) for each podcast. The descriptor indexer 50 extracts the descriptor metadata 27 from the text and embedded metatags of the content descriptor 25 and outputs it to a combiner 60. The content descriptor 25 can also be a simple web page link to a media file. The link can contain information in the text of the link that describes the file and can also include attributes in the HTML that describe the target media file.

In parallel, the media indexer 10 reads the metadata 27 from the content descriptor 25 and downloads the audio/video podcast 20 from the identified location. The media indexer 10 applies one or more automated media processing techniques to the downloaded podcast and outputs the combined results to the combiner 60. At the combiner 60, the metadata information from the media indexer 10 and the descriptor indexer 50 are combined in a predetermined format to form the enhanced metadata 30. The enhanced metadata 30 is then stored in the index 40 accessible to search-driven applications such as those disclosed herein.

In other embodiments, the descriptor indexer 50 is optional and the enhanced metadata is generated by the media indexer 10.

FIG. 1B is a diagram illustrating an example of a media indexer. As shown, the media indexer 10 includes a bank of media processors 100 that are managed by a media indexing controller 110. The media indexing controller 110 and each of the media processors 100 can be implemented, for example, using a suitably programmed or dedicated processor (e.g., a microprocessor or microcontroller), hardwired logic, Application Specific Integrated Circuit (ASIC), and a Programmable Logic Device (PLD) (e.g., Field Programmable Gate Array (FPGA)).

A content descriptor 25 is fed into the media indexing controller 110, which allocates one or more appropriate media processors 100a . . . 100n to process the media files/streams 20 identified in the metadata 27. Each of the assigned media processors 100 obtains the media file/stream (e.g., audio/video podcast) and applies a predefined set of audio or video processing routines to derive a portion of the enhanced metadata from the media content.

Examples of known media processors 100 include speech recognition processors 100a, natural language processors 100b, video frame analyzers 100c, non-speech audio analyzers 100d, marker extractors 100e and embedded metadata processors 100f. Other media processors known to those skilled in the art of audio and video analysis can also be implemented within the media indexer. The results of such media processing define timing boundaries of a number of content segment within a media file/stream, including timed word segments 105a, timed audio speech segments 105b, timed video segments 105c, timed non-speech audio segments 105d, timed marker segments 105e, as well as miscellaneous content attributes 105f, for example.

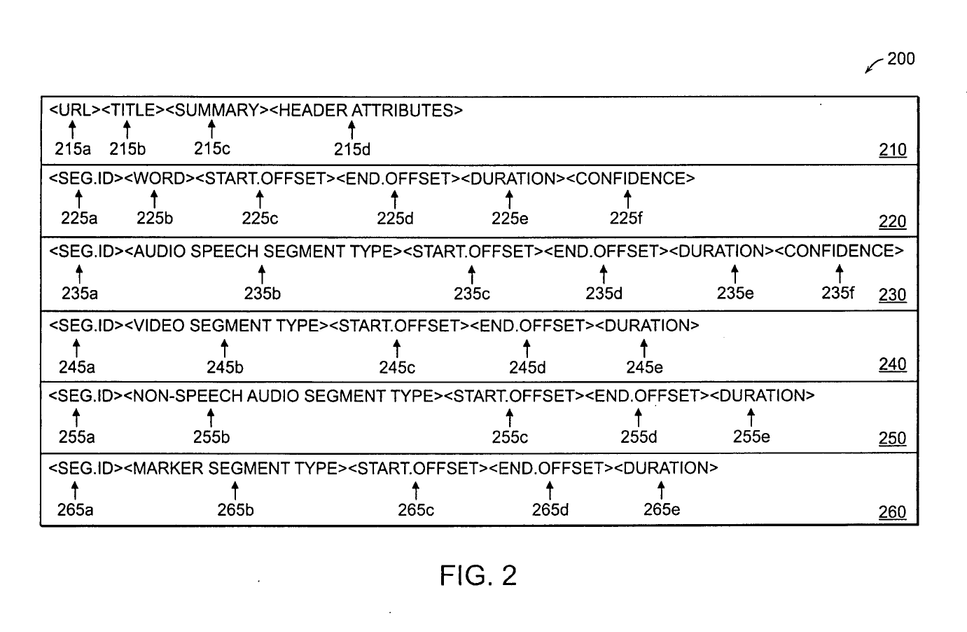

FIG. 2 is a diagram illustrating an example of metadata enhanced for audio/video search-driven applications. As shown, the enhanced metadata 200 include metadata 210 corresponding to the underlying media content generally. For example, where the underlying media content is an audio/video podcast, metadata 210 can include a URL 215a, title 215b, summary 215c, and miscellaneous content attributes 215d. Such information can be obtained from a content descriptor by the descriptor indexer 50. An example of a content descriptor is a Really Simple Syndication (RSS) document that is descriptive of one or more audio/video podcasts. Alternatively, such information can be extracted by an embedded metadata processor 100f from header fields embedded within the media file/stream according to a predetermined format.

The enhanced metadata 200 further identifies individual segments of audio/video content and timing information that defines the boundaries of each segment within the media file/stream. For example, in FIG. 2, the enhanced metadata 200 includes metadata that identifies a number of possible content segments within a typical media file/stream, namely word segments, audio speech segments, video segments, non-speech audio segments, and/or marker segments, for example.

The metadata 220 includes descriptive parameters for each of the timed word segments 225, including a segment identifier 225a, the text of an individual word 225b, timing information defining the boundaries of that content segment (i.e., start offset 225c, end offset 225d, and/or duration 225e), and optionally a confidence score 225f. The segment identifier 225a uniquely identifies each word segment amongst the content segments identified within the metadata 200. The text of the word segment 225b can be determined using a speech recognition processor 100a or parsed from closed caption data included with the media file/stream. The start offset 225c is an offset for indexing into the audio/video content to the beginning of the content segment. The end offset 225d is an offset for indexing into the audio/video content to the end of the content segment. The duration 225e indicates the duration of the content segment. The start offset, end offset and duration can each be represented as a timestamp, frame number or value corresponding to any other indexing scheme known to those skilled in the art. The confidence score 225f is a relative ranking (typically between 0 and 1) provided by the speech recognition processor 100a as to the accuracy of the recognized word.

The metadata 230 includes descriptive parameters for each of the timed audio speech segments 235, including a segment identifier 235a, an audio speech segment type 235b, timing information defining the boundaries of the content segment (e.g., start offset 235c, end offset 235d, and/or duration 235e), and optionally a confidence score 235f. The segment identifier 235a uniquely identifies each audio speech segment amongst the content segments identified within the metadata 200. The audio speech segment type 235b can be a numeric value or string that indicates whether the content segment includes audio corresponding to a phrase, a sentence, a paragraph, story or topic, particular gender, and/or an identified speaker. The audio speech segment type 235b and the corresponding timing information can be obtained using a natural language processor 100b capable of processing the timed word segments from the speech recognition processors 100a and/or the media file/stream 20 itself. The start offset 235c is an offset for indexing into the audio/video content to the beginning of the content segment. The end offset 235d is an offset for indexing into the audio/video content to the end of the content segment. The duration 235e indicates the duration of the content segment. The start offset, end offset and duration can each be represented as a timestamp, frame number or value corresponding to any other indexing scheme known to those skilled in the art. The confidence score 235f can be in the form of a statistical value (e.g., average, mean, variance, etc.) calculated from the individual confidence scores 225f of the individual word segments.

The metadata 240 includes descriptive parameters for each of the timed video segments 245, including a segment identifier 225a, a video segment type 245b, and timing information defining the boundaries of the content segment (e.g., start offset 245c, end offset 245d, and/or duration 245e). The segment identifier 245a uniquely identifies each video segment amongst the content segments identified within the metadata 200. The video segment type 245b can be a numeric value or string that indicates whether the content segment corresponds to video of an individual scene, watermark, recognized object, recognized face, or overlay text. The video segment type 245b and the corresponding timing information can be obtained using a video frame analyzer 100c capable of applying one or more image processing techniques. The start offset 235c is an offset for indexing into the audio/video content to the beginning of the content segment. The end offset 235d is an offset for indexing into the audio/video content to the end of the content segment. The duration 235e indicates the duration of the content segment. The start offset, end offset and duration can each be represented as a timestamp, frame number or value corresponding to any other indexing scheme known to those skilled in the art.

The metadata 250 includes descriptive parameters for each of the timed non-speech audio segments 255 include a segment identifier 225a, a non-speech audio segment type 255b, and timing information defining the boundaries of the content segment (e.g., start offset 255c, end offset 255d, and/or duration 255e). The segment identifier 255a uniquely identifies each non-speech audio segment amongst the content segments identified within the metadata 200. The audio segment type 235b can be a numeric value or string that indicates whether the content segment corresponds to audio of non-speech sounds, audio associated with a speaker emotion, audio within a range of volume levels, or sound gaps, for example. The non-speech audio segment type 255b and the corresponding timing information can be obtained using a non-speech audio analyzer 100d. The start offset 255c is an offset for indexing into the audio/video content to the beginning of the content segment. The end offset 255d is an offset for indexing into the audio/video content to the end of the content segment. The duration 255e indicates the duration of the content segment. The start offset, end offset and duration can each be represented as a timestamp, frame number or value corresponding to any other indexing scheme known to those skilled in the art.

The metadata 260 includes descriptive parameters for each of the timed marker segments 265, including a segment identifier 265a, a marker segment type 265b, timing information defining the boundaries of the content segment (e.g., start offset 265c, end offset 265d, and/or duration 265e). The segment identifier 265a uniquely identifies each video segment amongst the content segments identified within the metadata 200. The marker segment type 265b can be a numeric value or string that can indicates that the content segment corresponds to a predefined chapter or other marker within the media content (e.g., audio/video podcast). The marker segment type 265b and the corresponding timing information can be obtained using a marker extractor 100e to obtain metadata in the form of markers (e.g., chapters) that are embedded within the media content in a manner known to those skilled in the art.

By generating or otherwise obtaining such enhanced metadata that identifies content segments and corresponding timing information from the underlying media content, a number of for audio/video search-driven applications can be implemented as described herein.

Audio/Video Search Snippets

According to another aspect, the invention features a computerized method and apparatus for generating and presenting search snippets that enable user-directed navigation of the underlying audio/video content. The method involves obtaining metadata associated with discrete media content that satisfies a search query. The metadata identifies a number of content segments and corresponding timing information derived from the underlying media content using one or more automated media processing techniques. Using the timing information identified in the metadata, a search result or “snippet” can be generated that enables a user to arbitrarily select and commence playback of the underlying media content at any of the individual content segments.

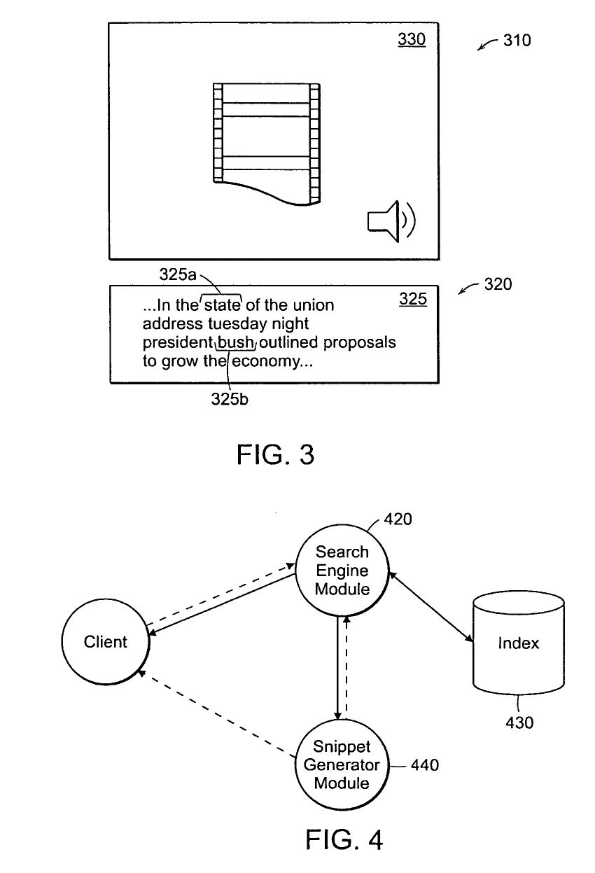

FIG. 3 is a diagram illustrating an example of a search snippet that enables user-directed navigation of underlying media content. The search snippet 310 includes a text area 320 displaying the text 325 of the words spoken during one or more content segments of the underlying media content. A media player 330 capable of audio/video playback is embedded within the search snippet or alternatively executed in a separate window.

The text 325 for each word in the text area 320 is preferably mapped to a start offset of a corresponding word segment identified in the enhanced metadata. For example, an object (e.g. SPAN object) can be defined for each of the displayed words in the text area 320. The object defines a start offset of the word segment and an event handler. Each start offset can be a timestamp or other indexing value that identifies the start of the corresponding word segment within the media content. Alternatively, the text 325 for a group of words can be mapped to the start offset of a common content segment that contains all of those words. Such content segments can include a audio speech segment, a video segment, or a marker segment, for example, as identified in the enhanced metadata of FIG. 2.

Playback of the underlying media content occurs in response to the user selection of a word and begins at the start offset corresponding to the content segment mapped to the selected word or group of words. User selection can be facilitated, for example, by directing a graphical pointer over the text area 320 using a pointing device and actuating the pointing device once the pointer is positioned over the text 325 of a desired word. In response, the object event handler provides the media player 330 with a set of input parameters, including a link to the media file/stream and the corresponding start offset, and directs the player 330 to commence or otherwise continue playback of the underlying media content at the input start offset.

For example, referring to FIG. 3, if a user clicks on the word 325a, the media player 330 begins to plays back the media content at the audio/video segment starting with “state of the union address . . . ” Likewise, if the user clicks on the word 325b, the media player 330 commences playback of the audio/video segment starting with “bush outlined . . . ”

An advantage of this aspect of the invention is that a user can read the text of the underlying audio/video content displayed by the search snippet and then actively “jump to” a desired segment of the media content for audio/video playback without having to listen to or view the entire media stream.

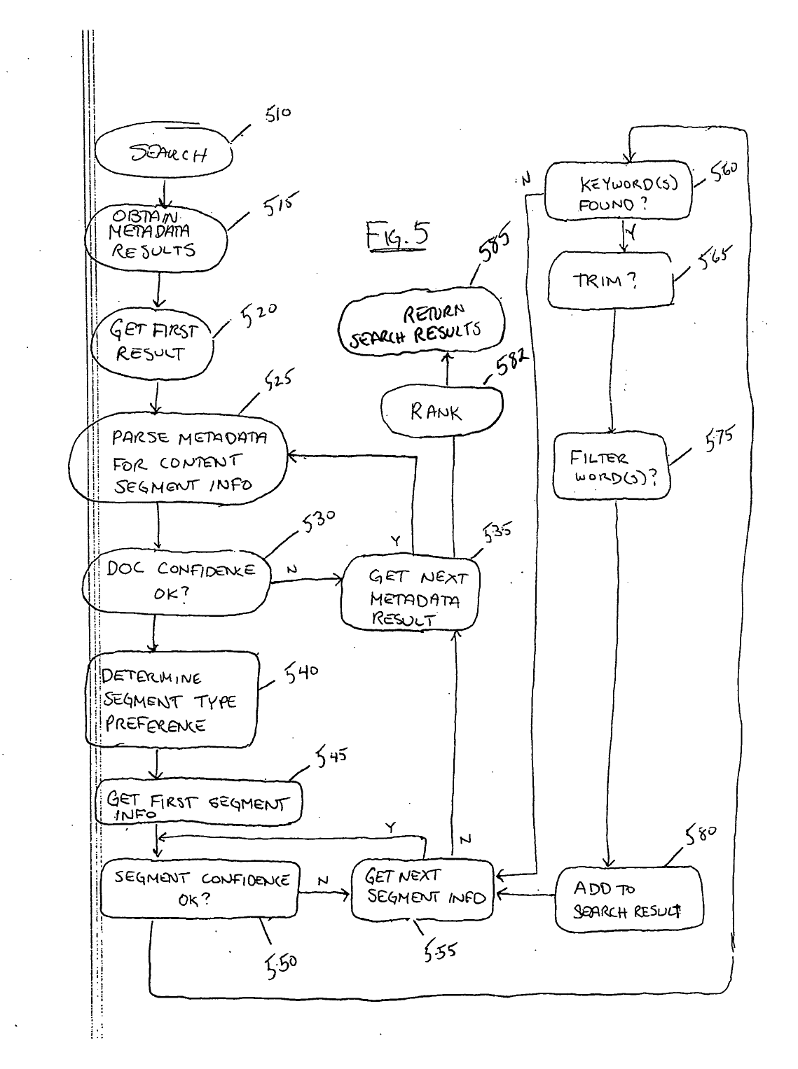

FIGS. 4 and 5 are diagrams illustrating a computerized method and apparatus for generating search snippets that enable user navigation of the underlying media content. Referring to FIG. 4, a client 410 interfaces with a search engine module 420 for searching an index 430 for desired audio/video content. The index includes a plurality of metadata associated with a number of discrete media content and enhanced for audio/video search as shown and described with reference to FIG. 2. The search engine module 420 also interfaces with a snippet generator module 440 that processes metadata satisfying a search query to generate the navigable search snippet for audio/video content for the client 410. Each of these modules can be implemented, for example, using a suitably programmed or dedicated processor (e.g., a microprocessor or microcontroller), hardwired logic, Application Specific Integrated Circuit (ASIC), and a Programmable Logic Device (PLD) (e.g., Field Programmable Gate Array (FPGA)).

FIG. 5 is a flow diagram illustrating a computerized method for generating search snippets that enable user-directed navigation of the underlying audio/video content. At step 510, the search engine 420 conducts a keyword search of the index 430 for a set of enhanced metadata documents satisfying the search query. At step 515, the search engine 420 obtains the enhanced metadata documents descriptive of one or more discrete media files/streams (e.g., audio/video podcasts).

At step 520, the snippet generator 440 obtains an enhanced metadata document corresponding to the first media file/stream in the set. As previously discussed with respect to FIG. 2, the enhanced metadata identifies content segments and corresponding timing information defining the boundaries of each segment within the media file/stream.

At step 525, the snippet generator 440 reads or parses the enhanced metadata document to obtain information on each of the content segments identified within the media file/stream. For each content segment, the information obtained preferably includes the location of the underlying media content (e.g. URL), a segment identifier, a segment type, a start offset, an end offset (or duration), the word or the group of words spoken during that segment, if any, and an optional confidence score.

Step 530 is an optional step in which the snippet generator 440 makes a determination as to whether the information obtained from the enhanced metadata is sufficiently accurate to warrant further search and/or presentation as a valid search snippet. For example, as shown in FIG. 2, each of the word segments 225 includes a confidence score 225f assigned by the speech recognition processor 100a. Each confidence score is a relative ranking (typically between 0 and 1) as to the accuracy of the recognized text of the word segment. To determine an overall confidence score for the enhanced metadata document in its entirety, a statistical value (e.g., average, mean, variance, etc.) can be calculated from the individual confidence scores of all the word segments 225.

Thus, if, at step 530, the overall confidence score falls below a predetermined threshold, the enhanced metadata document can be deemed unacceptable from which to present any search snippet of the underlying media content. Thus, the process continues at steps 535 and 525 to obtain and read/parse the enhanced metadata document corresponding to the next media file/stream identified in the search at step 510. Conversely, if the confidence score for the enhanced metadata in its entirety equals or exceeds the predetermined threshold, the process continues at step 540.

At step 540, the snippet generator 440 determines a segment type preference. The segment type preference indicates which types of content segments to search and present as snippets. The segment type preference can include a numeric value or string corresponding to one or more of the segment types. For example, if the segment type preference can be defined to be one of the audio speech segment types, e.g., “story,” the enhanced metadata is searched on a story-by-story basis for a match to the search query and the resulting snippets are also presented on a story-by-story basis. In other words, each of the content segments identified in the metadata as type “story” are individually searched for a match to the search query and also presented in a separate search snippet if a match is found. Likewise, the segment type preference can alternatively be defined to be one of the video segment types, e.g., individual scene. The segment type preference can be fixed programmatically or user configurable.

At step 545, the snippet generator 440 obtains the metadata information corresponding to a first content segment of the preferred segment type (e.g., the first story segment). The metadata information for the content segment preferably includes the location of the underlying media file/stream, a segment identifier, the preferred segment type, a start offset, an end offset (or duration) and an optional confidence score. The start offset and the end offset/duration define the timing boundaries of the content segment. By referencing the enhanced metadata, the text of words spoken during that segment, if any, can be determined by identifying each of the word segments falling within the start and end offsets. For example, if the underlying media content is an audio/video podcast of a news program and the segment preference is “story,” the metadata information for the first content segment includes the text of the word segments spoken during the first news story.

Step 550 is an optional step in which the snippet generator 440 makes a determination as to whether the metadata information for the content segment is sufficiently accurate to warrant further search and/or presentation as a valid search snippet. This step is similar to step 530 except that the confidence score is a statistical value (e.g., average, mean, variance, etc.) calculated from the individual confidence scores of the word segments 225 falling within the timing boundaries of the content segment.

If the confidence score falls below a predetermined threshold, the process continues at step 555 to obtain the metadata information corresponding to a next content segment of the preferred segment type. If there are no more content segments of the preferred segment type, the process continues at step 535 to obtain the enhanced metadata document corresponding to the next media file/stream identified in the search at step 510. Conversely, if the confidence score of the metadata information for the content segment equals or exceeds the predetermined threshold, the process continues at step 560.

At step 560, the snippet generator 440 compares the text of the words spoken during the selected content segment, if any, to the keyword(s) of the search query. If the text derived from the content segment does not contain a match to the keyword search query, the metadata information for that segment is discarded. Otherwise, the process continues at optional step 565.

At optional step 565, the snippet generator 440 trims the text of the content segment (as determined at step 545) to fit within the boundaries of the display area (e.g., text area 320 of FIG. 3). According to one embodiment, the text can be trimmed by locating the word(s) matching the search query and limiting the number of additional words before and after. According to another embodiment, the text can be trimmed by locating the word(s) matching the search query, identifying another content segment that has a duration shorter than the segment type preference and contains the matching word(s), and limiting the displayed text of the search snippet to that of the content segment of shorter duration. For example, assuming that the segment type preference is of type “story,” the displayed text of the search snippet can be limited to that of segment type “sentence” or “paragraph”.

At optional step 575, the snippet generator 440 filters the text of individual words from the search snippet according to their confidence scores. For example, in FIG. 2, a confidence score 225f is assigned to each of the word segments to represent a relative ranking that corresponds to the accuracy of the text of the recognized word. For each word in the text of the content segment, the confidence score from the corresponding word segment 225 is compared against a predetermined threshold value. If the confidence score for a word segment falls below the threshold, the text for that word segment is replaced with a predefined symbol (e.g., - - - ). Otherwise no change is made to the text for that word segment.

At step 580, the snippet generator 440 adds the resulting metadata information for the content segment to a search result for the underlying media stream/file. Each enhanced metadata document that is returned from the search engine can have zero, one or more content segments containing a match to the search query. Thus, the corresponding search result associated with the media file/stream can also have zero, one or more search snippets associated with it. An example of a search result that includes no search snippets occurs when the metadata of the original content descriptor contains the search term, but the timed word segments 105a of FIG. 2 do not.

The process returns to step 555 to obtain the metadata information corresponding to the next content snippet segment of the preferred segment type. If there are no more content segments of the preferred segment type, the process continues at step 535 to obtain the enhanced metadata document corresponding to the next media file/stream identified in the search at step 510. If there are no further metadata results to process, the process continues at optional step 582 to rank the search results before sending to the client 410.

At optional step 582, the snippet generator 440 ranks and sorts the list of search results. One factor for determining the rank of the search results can include confidence scores. For example, the search results can be ranked by calculating the sum, average or other statistical value from the confidence scores of the constituent search snippets for each search result and then ranking and sorting accordingly. Search results being associated with higher confidence scores can be ranked and thus sorted higher than search results associated with lower confidence scores. Other factors for ranking search results can include the publication date associated with the underlying media content and the number of snippets in each of the search results that contain the search term or terms. Any number of other criteria for ranking search results known to those skilled in the art can also be utilized in ranking the search results for audio/video content.

At step 585, the search results can be returned in a number of different ways. According to one embodiment, the snippet generator 440 can generate a set of instructions for rendering each of the constituent search snippets of the search result as shown in FIG. 3, for example, from the raw metadata information for each of the identified content segments. Once the instructions are generated, they can be provided to the search engine 420 for forwarding to the client. If a search result includes a long list of snippets, the client can display the search result such that a few of the snippets are displayed along with an indicator that can be selected to show the entire set of snippets for that search result.

Although not so limited, such a client includes (i) a browser application that is capable of presenting graphical search query forms and resulting pages of search snippets; (ii) a desktop or portable application capable of, or otherwise modified for, subscribing to a service and receiving alerts containing embedded search snippets (e.g., RSS reader applications); or (iii) a search applet embedded within a DVD (Digital Video Disc) that allows users to search a remote or local index to locate and navigate segments of the DVD audio/video content.

According to another embodiment, the metadata information contained within the list of search results in a raw data format are forwarded directly to the client 410 or indirectly to the client 410 via the search engine 420. The raw metadata information can include any combination of the parameters including a segment identifier, the location of the underlying content (e.g., URL or filename), segment type, the text of the word or group of words spoken during that segment (if any), timing information (e.g., start offset, end offset, and/or duration) and a confidence score (if any). Such information can then be stored or further processed by the client 410 according to application specific requirements. For example, a client desktop application, such as iTunes Music Store available from Apple Computer, Inc., can be modified to process the raw metadata information to generate its own proprietary user interface for enabling user-directed navigation of media content, including audio/video podcasts, resulting from a search of its Music Store repository.

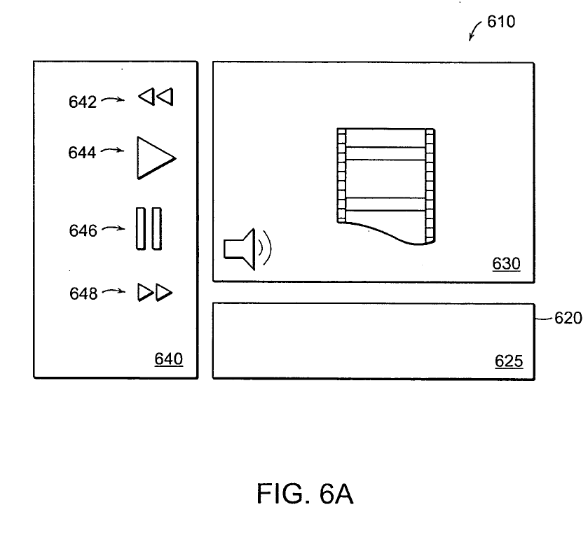

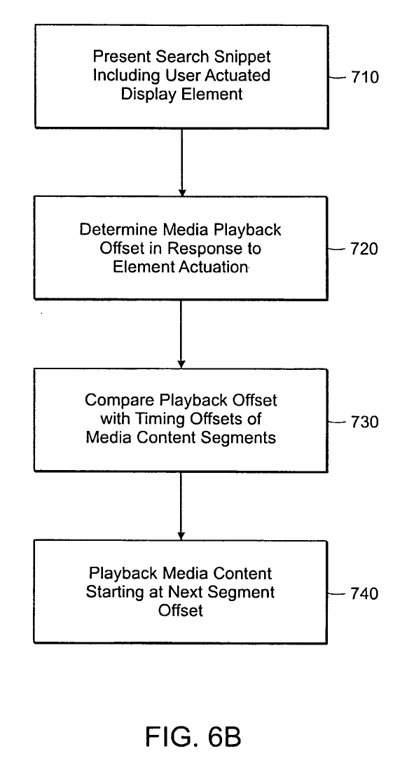

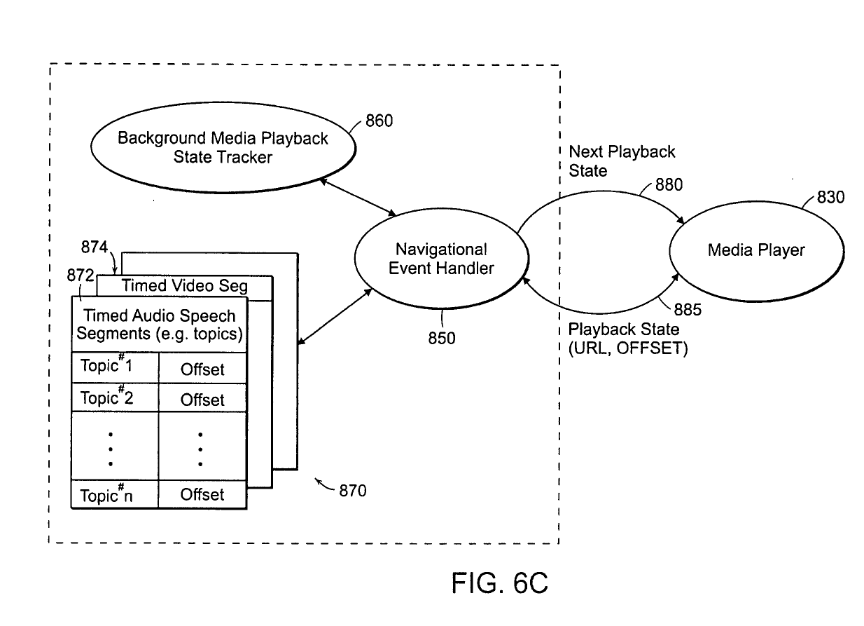

FIG. 6A is a diagram illustrating another example of a search snippet that enables user navigation of the underlying media content. The search snippet 610 is similar to the snippet described with respect to FIG. 3, and additionally includes a user actuated display element 640 that serves as a navigational control. The navigational control 640 enables a user to control playback of the underlying media content. The text area 620 is optional for displaying the text 625 of the words spoken during one or more segments of the underlying media content as previously discussed with respect to FIG. 3.

Typical fast forward and fast reverse functions cause media players to jump ahead or jump back during media playback in fixed time increments. In contrast, the navigational control 640 enables a user to jump from one content segment to another segment using the timing information of individual content segments identified in the enhanced metadata.

As shown in FIG. 6A, the user-actuated display element 640 can include a number of navigational controls (e.g., Back 642, Forward 648, Play 644, and Pause 646). The Back 642 and Forward 648 controls can be configured to enable a user to jump between word segments, audio speech segments, video segments, non-speech audio segments, and marker segments. For example, if an audio/video podcast includes several content segments corresponding to different stories or topics, the user can easily skip such segments until the desired story or topic segment is reached.

FIGS. 6B and 6C are diagrams illustrating a method for navigating media content using the search snippet of FIG. 6A. At step 710, the client presents the search snippet of FIG. 6A, for example, that includes the user actuated display element 640. The user-actuated display element 640 includes a number of individual navigational controls (i.e., Back 642, Forward 648, Play 644, and Pause 646). Each of the navigational controls 642, 644, 646, 648 is associated with an object defining at least one event handler that is responsive to user actuations. For example, when a user clicks on the Play control 644, the object event handler provides the media player 630 with a link to the media file/stream and directs the player 630 to initiate playback of the media content from the beginning of the file/stream or from the most recent playback offset.

At step 720, in response to an indication of user actuation of Forward 648 and Back 642 display elements, a playback offset associated with the underlying media content in playback is determined. The playback offset can be a timestamp or other indexing value that varies according to the content segment presently in playback. This playback offset can be determined by polling the media player or by autonomously tracking the playback time.

For example, as shown in FIG. 6C, when the navigational event handler 850 is triggered by user actuation of the Forward 648 or Back 642 control elements, the playback state of media player module 830 is determined from the identity of the media file/stream presently in playback (e.g., URL or filename), if any, and the playback timing offset. Determination of the playback state can be accomplished by a sequence of status request/response 855 signaling to and from the media player module 830. Alternatively, a background media playback state tracker module 860 can be executed that keeps track of the identity of the media file in playback and maintains a playback clock (not shown) that tracks the relative playback timing offsets.

At step 730 of FIG. 6B, the playback offset is compared with the timing information corresponding to each of the content segments of the underlying media content to determine which of the content segments is presently in playback. As shown in FIG. 6C, once the media file/stream and playback timing offset are determined, the navigational event handler 850 references a segment list 870 that identifies each of the content segments in the media file/stream and the corresponding timing offset of that segment. As shown, the segment list 870 includes a segment list 872 corresponding to a set of timed audio speech segments (e.g., topics). For example, if the media file/stream is an audio/video podcast of an episode of a daily news program, the segment list 872 can include a number of entries corresponding to the various topics discussed during that episode (e.g., news, weather, sports, entertainment, etc.) and the time offsets corresponding to the start of each topic. The segment list 870 can also include a video segment list 874 or other lists (not shown) corresponding to timed word segments, timed non-speech audio segments, and timed marker segments, for example. The segment lists 870 can be derived from the enhanced metadata or can be the enhanced metadata itself.

At step 740 of FIG. 6B, the underlying media content is played back at an offset that is prior to or subsequent to the offset of the content segment presently in playback. For example, referring to FIG. 6C, the event handler 850 compares the playback timing offset to the set of predetermined timing offsets in one or more of the segment lists 870 to determine which of the content segments to playback next. For example, if the user clicked on the “forward” control 848, the event handler 850 obtains the timing offset for the content segment that is greater in time than the present playback offset. Conversely, if the user clicks on the “backward” control 842, the event handler 850 obtains the timing offset for the content segment that is earlier in time than the present playback offset. After determining the timing offset of the next segment to play, the event handler 850 provides the media player module 830 with instructions 880 directing playback of the media content at the next playback state (e.g., segment offset and/or URL).

Thus, an advantage of this aspect of the invention is that a user can control media using a client that is capable of jumping from one content segment to another segment using the timing information of individual content segments identified in the enhanced metadata. One particular application of this technology can be applied to portable player devices, such as the iPod audio/video player available from Apple Computer, Inc. For example, after downloading a podcast to the iPod, it is unacceptable for a user to have to listen to or view an entire podcast if he/she is only interested in a few segments of the content. Rather, by modifying the internal operating system software of iPod, the control buttons on the front panel of the iPod can be used to jump from one segment to the next segment of the podcast in a manner similar to that previously described.

Updating Speech Recognition Databases and Reindexing Audio Video Content Using the Same

According to another aspect, the present invention features methods and apparatus to refine the search of information that is created by non-perfect methods. For example, Speech Recognition and Natural Language Processing techniques currently produce inexact output. Techniques for converting speech to text or to perform topic spotting or named entity extraction from documents have some error rate that can be measured. In addition, as more processing power becomes available and new methods are refined, the techniques get more accurate. When a media file is transcribed using automated methods, the output is fixed to the state of the art and current dictionary at the time the file is processed. As the state of the art improves, previously indexed files do not receive the benefit of the new state of the art processing, dictionaries, and language models. For example, if a new major event happens (like Hurricane Katrina) and people begin to search for the terms, the current models may not contain them and the searches will be quite poor.

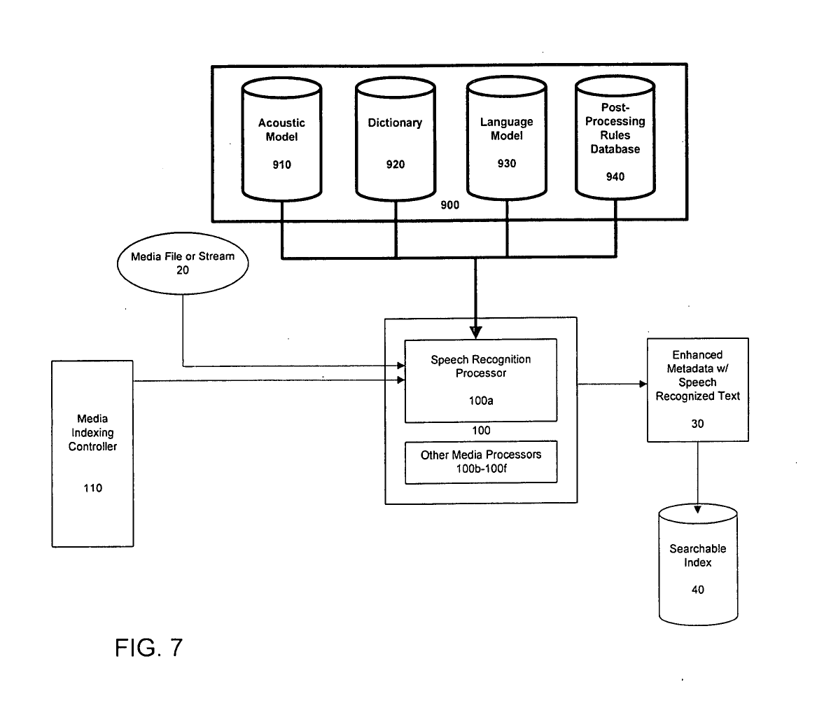

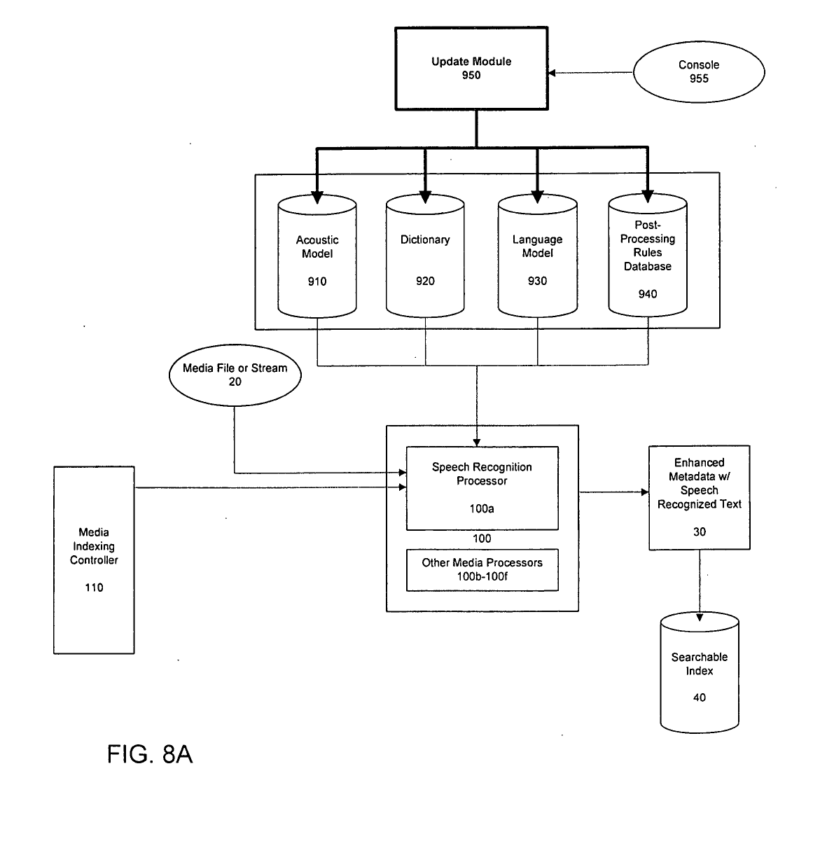

FIG. 7 is a diagram illustrating a back-end multimedia search system including a speech recognition database. Episodic content descriptors are fed into a media indexing controller 110. An example of such descriptors include RSS feeds, which in essence syndicates the content available on a particular site. An RSS is generally in the form of an XML document which summaries specific site content, such as news, blog posts, etc. As the RSS feeds are received by the system, the media indexing controller 110 distributes the files across a bank of media processors 100. Each RSS feed can include metadata that is descriptive of one or more media files or streams (e.g., audio or video). Such descriptive information typically includes a title, a URL to the media resource, and a brief description of the contents of the media. However, it does not include detailed information about the actual contents of that media.

One or more media processors 100a-100f, such as those previously described in FIG. 1B, can read the RSS feed or other episodic content descriptor and optionally download the actual media resource 20. In the case of a media resource containing audio, such as an MP3 or MPEG file, a speech recognition processor 100a can access the speech recognition database 900 to analyze the audio resource and generate an index including a sequence of recognized words and optionally corresponding timing information (e.g., timestamp, start offset, and end offset or duration) for each word into the audio stream. The sequence of words can be further processed by other media processors 100b-100f, such as a natural language processor, that is capable of identifying sentence boundaries, named entities, topics, and story segmentations, for example.

The information from the media processors 100a-100f can then be merged into an enhanced episode meta data 30 that contains the original metadata of the content descriptor as well as detailed information regarding the contents of the actual media resource, such as speech recognized text with timestamps, segment lists, topic lists, and a hash of the original file. Such enhanced metadata can be stored in a searchable database or other index 40 accessible to search engines, RSS feeds, and other applications in which search of media resources is desired.

In the context of speech recognition, a number of databases 900 are used to recognize a word or sequence of words from a string of audible phonemes. Such databases 900 include an acoustical model 910, a dictionary 920, a language model (or domain model) 930, and optionally a post-processing rules database 940. The acoustic model 910 stores the phonemes associated with a set of core acoustic sounds. The dictionary 920 includes the text of a set of unigrams (i.e. individual words) mapped to a corresponding set of phonemes (i.e., the audible representation of the corresponding words). The language model 930 includes the text of a set of bigrams, trigrams and other n-grams (i.e., multi-word strings associated with probabilities). For example, bigrams correspond to two words in series and trigrams correspond to three words in series. Each bigram and trigram in the language model is mapped to the constituent unigrams in the dictionary. In addition, groups of n-grams having similar sequences of phonemes can be weighted relative to one another, such that n-grams having higher weights can be recognized more often than n-grams of lesser weights. The speech recognition module 100a uses these databases to translate detected sequences of phonemes in an audible stream to a corresponding series of words. The speech recognition module 100a can also use the post-processing rules database 940 to replace portions of the speech recognized text according to predefined rule sets. For example, one rule can replace the word “socks” with “sox” if it is preceded by the term “boston red.” Other more complex rule strategies can be implemented based on information obtained from metadata, natural language processing, topic spotting techniques, and other methods for determining the context of the media content. The accuracy of a speech recognition processor 100a depends on the contents of the speech recognition database 900 and other factors (such as audio quality).

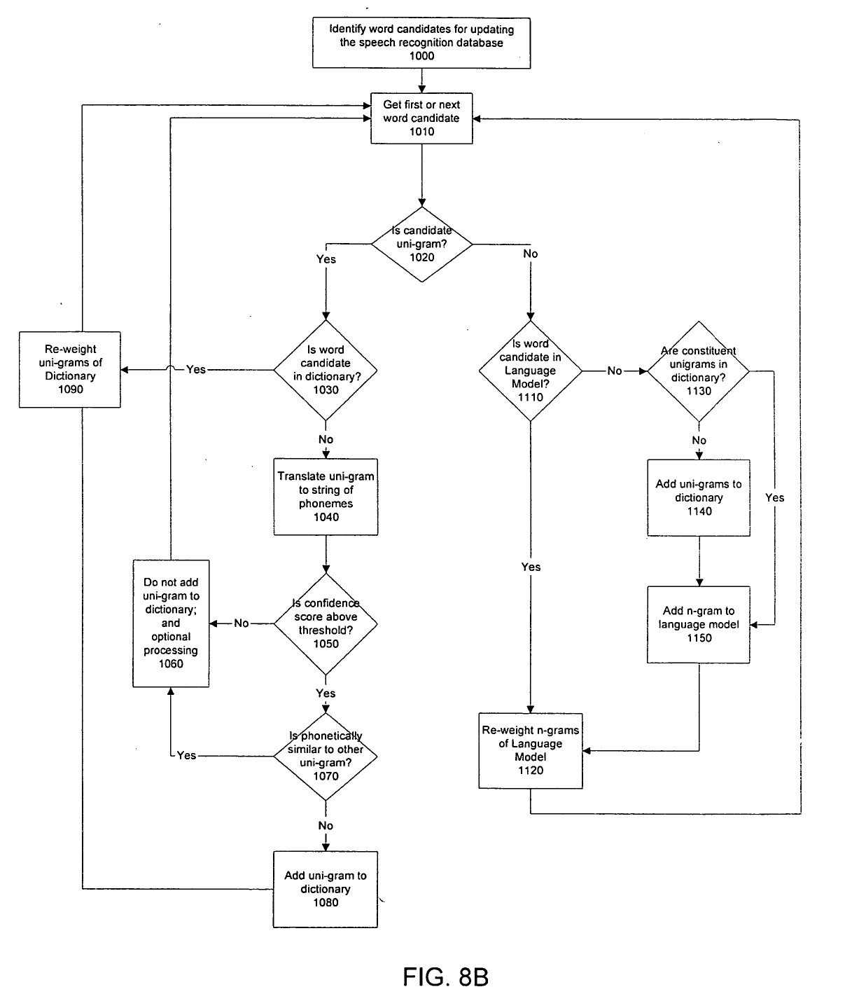

Thus, according to another aspect, the present invention features a method and apparatus for updating the databases used for speech recognition. FIGS. 8A and 8B illustrate a system and method for updating a speech recognition database. As shown, FIG. 8A illustrates an update module 950 which identifies a set of words serving as candidates from which to update the speech recognition database 900. The update module 950 interacts with the speech recognition database 900 to update the dictionary 920, language model 930, post-processing rules database 940 or combinations thereof.

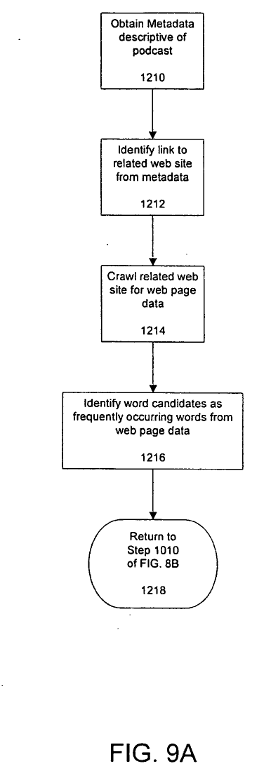

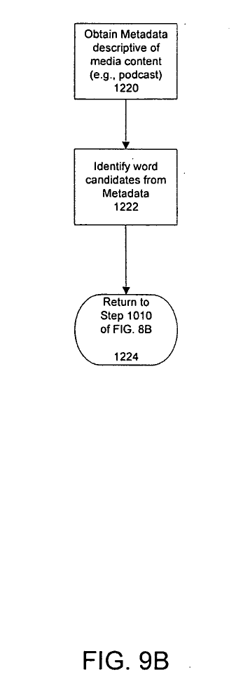

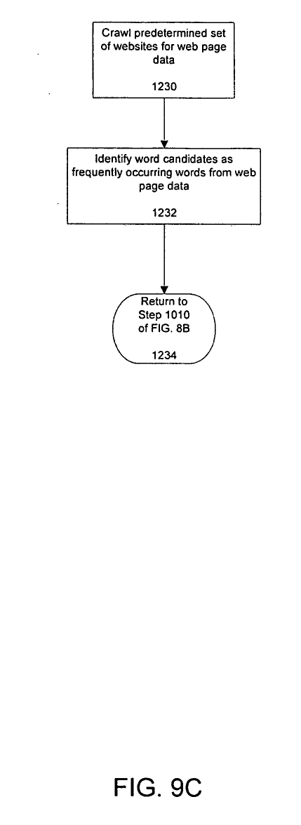

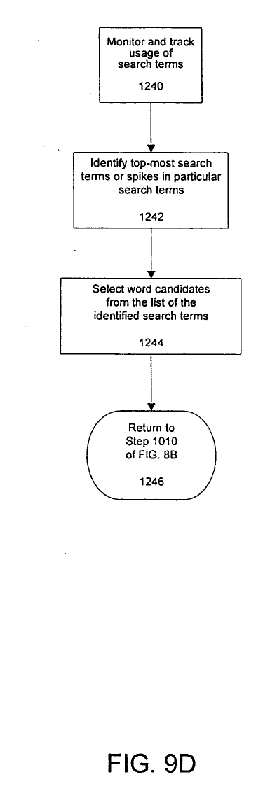

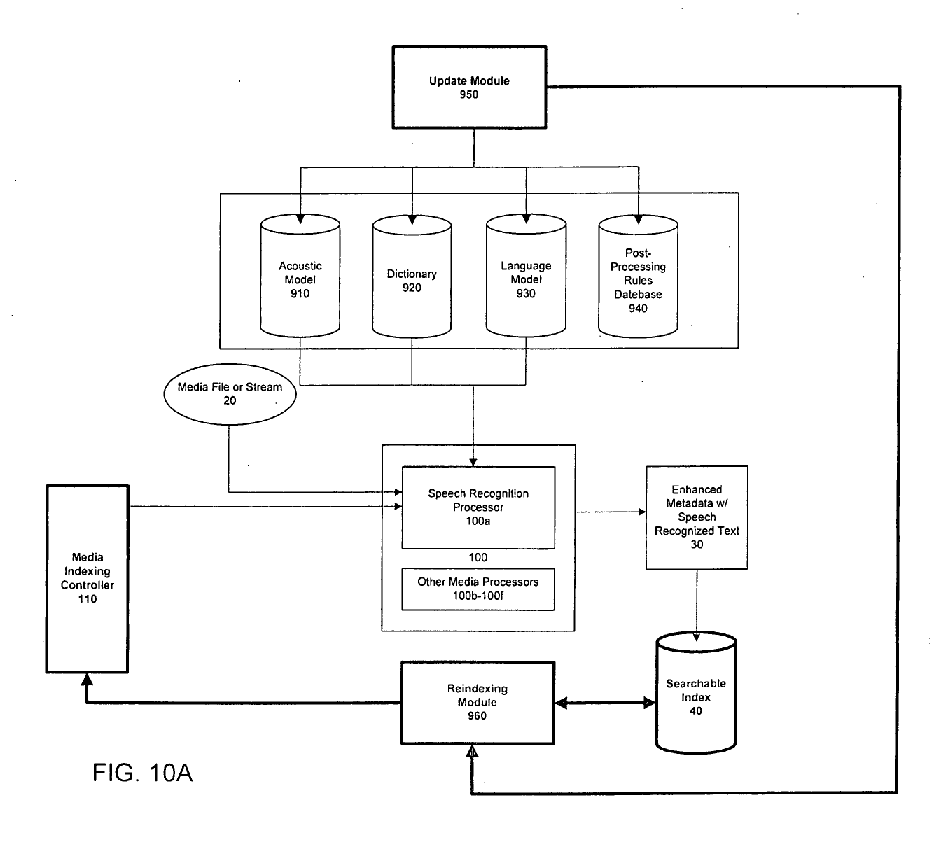

FIG. 8B is a flow diagram illustrating a method for updating a speech recognition database. At step 1000, the update module 950 identifies a set of word candidates for updating the dictionary 920, language model 930, post-processing rules database 940 or combination thereof. Although not so limited, the set of word candidates can include (i) words appearing in the search requests received by a search engine, (ii) words appearing in metadata corresponding to a media file or stream (e.g., podcast); (iii) words appearing in pages of selected web sites for news, finance, sports, entertainment, etc.; and (iv) words appearing in pages of a website related to the source of the media file or stream. Examples of such methods for identifying word candidates are discussed with respect to FIGS. 9A-9D. Other methods known to those skilled in the art for identifying a set of word candidates can also be implemented.

At step 1010, the update module 1000 retrieves the first word candidate. Step 1020 determines the processing path of the word candidate which depends on whether the word candidate is a unigram (single word) or a multi-word string, such as a bigram or trigram. If the word candidate is a unigram, the update module 950 determines, at step 1030, whether the dictionary 920 includes an entry that defines an acoustical representation of the unigram, typically in the form of a string of phonemes. A phoneme is a basic, theoretical unit of sound that can distinguish words in terms of, for example, meaning or pronunciation.

If the dictionary 920 includes an entry for the word candidate, the update module 950 increases the weight of the corresponding unigram in the dictionary 920 at step 1090 and then returns to step 1010 to obtain the next word candidate. For example, if there are two unigrams having similar phoneme strings matching a portion of the audio stream, the speech recognition processor 100a can use the assigned weights of the unigrams as a factor in selecting the appropriate unigram. A unigram of a greater weight is likely to be selected more than a unigram of a lesser weight.

If the dictionary 920 does not include an entry for the unigram word candidate, the update module 950 initiates a process for to add the unigram to the dictionary. For example, at step 1040, the update module 950 translates, or directs another module (not shown) to translate, the unigram into a string of phonemes. Any text-to-speech engine or technique known to one skilled in the art can be implemented for this translation step. This mapping of the unigram to the string of phonemes can then be stored into the dictionary 920 at step 1080.

Optionally, at step 1040, the update module 950 can associate a confidence score with the mapping of the unigram to the string of phonemes. This confidence score is a value that represents the accuracy of the mapping that is assigned according to the text-to-speech engine or technique. If, at step 1050, the confidence score fails to satisfy a pre-determined threshold (e.g. score is less than threshold), the unigram is not automatically added to the dictionary 920 (step 1060). Rather, a manual process can be invoked in which a human operator can intervene using console 955 to verify the unigram-to-phoneme mapping or create a new mapping that can be entered into the dictionary 920. If, at step 1050, the confidence score satisfies the predetermined threshold (e.g. equals or exceeds the threshold), the mapping of the unigram to the string of phonemes can then be stored into the dictionary 920 at step 1080.

A unigram-to-phoneme mapping for a word candidate can be phonetically similar to another unigram already stored in the dictionary. For example, if the unigram word candidate is “Sox,” such as in the Boston Red Sox baseball team, the string of phonemes can be similar, if not identical, to the string of phonemes mapped to the word “socks” in the dictionary 920. In such instances where the phoneme string of unigram word candidate is similar to the phoneme string of a word already maintained in the dictionary 920, step 1060 can drop the word candidate from the dictionary.

Optionally, rather than dropping the word candidate altogether at step 1060, the newly created unigram-to-phoneme mapping can be added to a context-sensitive dictionary which stores words associated with particular categories. For example, the word candidate “Sox” can be added to a dictionary that defines acoustical mappings for sports related words. Thus, when the speech recognition processor 100a analyzes an audio or video podcast from ESPN (Entertainment and Sports Programming Network), for example, the processor can reference both the main dictionary and the sports-related dictionary to translate the audio to text.

According to another optional embodiment, rather than dropping the word candidate altogether at step 1060, a manual process can be invoked in which a human operator enters a rule or set of rules through a console 955 into the post-processing rules database 940 for replacing portions of speech recognized text. The rule or set of rules stored in the rules database 940 can be accessible to the speech recognition module 100a during a post-processing step of the speech recognition text.

At step 1080, the unigram-to-phoneme mapping is added to the dictionary 920. This can be accomplished by the update module 950 communicating directly with the dictionary 920 or indirectly through an intervening communication interface (not shown) between the dictionary 920 and the update module 950. After the unigram word candidate is entered into the dictionary 920, the weights associated with the unigrams in the dictionary 920 are adjusted as necessary at step 1090. After successful entry of the unigram to the dictionary 920, the update module returns to step 1010 to obtain the next word candidate.

If the word candidate is a multi-word string, such as a bigram or trigram, the update module 950 determines, at step 1110, whether the language model 930 includes an entry that defines an acoustical representation of the n-gram. For example, the term “boston red sox” can be stored in the language model as a trigram. This trigram is then mapped to the constituent unigrams (“boston” “red” “sox”) stored in the dictionary 920, which in turn are mapped to the constituent phonemes stored in the acoustic model 910.

If, at step 1110, the n-gram word candidate is found within the language model 930, the update module 940 proceeds to step 1120. At step 1120, the update module 940 adjusts the weight associated with the corresponding trigram in the dictionary 920 and then returns to step 1010 to obtain the next word candidate. For example, if there are two bigrams having similar phoneme strings (e.g., “red socks” and “red sox”) matching a portion of the audio stream, the speech recognition processor 100a can use the assigned weights of the bigrams as a factor in selecting the appropriate bigram. A n-gram of a greater weight is likely to be selected more than a unigram of a lesser weight.

Conversely, if at step 1110, the n-gram word candidate is not found within the language model 930, the update module 950 proceeds to step 1130 to determine whether the dictionary 920 includes entries for the constituent unigrams of the n-gram word candidate. For example, if the n-gram word candidate is “boston red sox,” the dictionary 920 is scanned for the constituent unigrams “boston,” “red,” and “sox”. If entries for the constituent unigrams are found in the dictionary 920, the n-gram word candidate is added to the language model 930 at step 1150 and mapped to the constituent unigrams in the dictionary 920.

If one or more of the constituent unigrams lack entries in the dictionary 920, the update module 950 causes the one or more missing unigrams to be added to the dictionary at step 1140. The missing unigrams can be added to the dictionary according to steps 1040 through 1090 as previously described. Once the constituent unigrams of the n-gram word candidate have been successfully entered into the dictionary 920, the update module 940 proceeds to step 1150 to add the n-gram word candidate to the language model 930 and map it to the constituent unigrams in the dictionary 920. Once the n-gram word candidate is successfully entered into the language model 930, the update module 940 proceeds to step 1120 where it adjusts the weights associated with n-gram in the dictionary 920 and then returns to step 1010 to obtain the next word candidate. FIGS. 9A-9D illustrate a number of examples in which a set of word candidates can be obtained from one or more sources.

FIG. 9A is a flow diagram illustrating a method for obtaining word candidates. According to this embodiment, the set of words include words appearing in pages of a website related to the source of the podcast or other media file or stream. At step 1210, the update module 950 obtains metadata descriptive of a media file or stream. At step 1212, the update module 950 identifies links to one or more related web sites from the metadata. At step 1214, the update module 940 scans or “crawls,” or otherwise directs another module to scan or crawl, the source web site and each of the related web sites to obtain data from each of the web pages from those sites. At step 1216, the update module 940 collects all of the textual data obtained or otherwise derived from the source and related web sites and analyzes the data to identify frequently occurring words from the web page data. At step 1218, these frequently occurring words are then included in the set of word candidates, which are processed by the update module 950 according to the method of FIG. 8B to update the speech recognition database 900.

For example, with respect to FIG. 7, the media index controller 110 receives metadata in the form of content descriptors. An RSS content descriptor includes, among others, a URL (Universal Resource Locator) link to the podcast or other media resource. From this link, the update module 950 can determine the source address of the website that publishes this podcast. Using the source address, the update module 950 can crawl, or direct another module to crawl, the source website for data from its constituent pages. If the source website includes links to, or otherwise references, other websites, the update module 950 can additionally crawl those sites for data as well.

The data can be text or multimedia from the web page. Where the data is multimedia data, additional processing may be necessary to obtain textual information. For example, if the multimedia data is an image, an image processor, such as an Optical Character Recognition (OCR) scanner, can be used to convert portions of the image to text. If the multimedia data is another audio or video file, the speech recognition processor 100a of FIG. 7 can be used to obtain textual information. The frequently-occurring words from the accumulated web page data are then added to a list of word candidates to be updated according to the method of FIG. 8B.

FIG. 9B is a flow diagram illustrating another method for obtaining word candidates. According to this embodiment, the set of word candidates include words appearing in the metadata corresponding to a podcast or other media file or stream. In other words, the original metadata can be used as a clue to update the sequence of recognized words in the enhanced metadata. For example, in the case where a homophone of words are found in the original metadata appears in the enhanced metadata, some simple unigram, bigram, or trigram analysis of the enhanced metadata can determine whether the sequence can be immediately corrected. For example, if “Harriet Myers” appears in the enhanced metadata, and the similar sounding “Harriet Miers” appears in the original metadata, the enhanced metadata can immediately be changed to “Harriet Miers.”

At step 1220, the update module 940 obtains metadata descriptive of a media file or stream. Such metadata can be contained in a document separate from the podcast or other media resource. For example, the metadata can be in the form of an RSS content descriptor, which typically includes a title of the podcast, a summary of the contents of the podcast, and a URL (Universal Resource Locator) link to the podcast. Alternatively, the metadata can be in the form of a web page that can provide information in a variety of formats, including text and multimedia data. The metadata can also be embedded within the media resource. Chapter markers and embedded tags are examples.

At step 1222, the update module 940 identifies word candidates from the metadata. For example, in the case where the metadata is in the form of an RSS content descriptor, that word candidates can be obtained from the title, summary and the text of the link to the podcast. Where the metadata is in the form of a standard web page, word candidates can be obtained from the text as well as multimedia content of the web page. Where the data is multimedia data, additional processing may be necessary to obtain textual information. For example, if the multimedia data is an image, an image processor, such as an Optical Character Recognition (OCR) scanner, can be used to convert portions of the image to text. If the multimedia data is another audio or video file, the speech recognition processor 100a of FIG. 7 can be used to obtain textual information. The word candidates can also be obtained from the data embedded in the media resource itself. At step 1224, these word candidates are then processed by the update module 950 according to the method of FIG. 8B to update the speech recognition database 900.

FIG. 9C is a flow diagram illustrating another method for obtaining word candidates. According to this embodiment, the set of word candidates includes words appearing in pages of selected web sites. At step 1230, the update module 940 scans or “crawls,” or otherwise directs another module to scan or crawl, a predetermined set of web sites to obtain web page data. The set of web sites can be selected according to any criteria. For example, the web sites can be selected from the top web sites that provide information regarding a broad set of categories, such as sports, entertainment, weather, business, politics, science for example. As previously discussed, the data collected from these sites can be text or multimedia from the web page. Where the data is multimedia data, additional processing may be necessary to obtain textual information.

At step 1232, the update module 940 collects all of the textual data obtained or otherwise derived from the source and related web sites and analyzes the data to identify frequently occurring words from the web page data. These frequently occurring words are then included in the set of word candidates, which are processed by the update module 940 according to the method of FIG. 8B to update the speech recognition database 900. At step 1234, these word candidates are then processed by the update module 950 according to the method of FIG. 8B to update the speech recognition database 900.

FIG. 9D is a flow diagram illustrating another method for obtaining word candidates. According to this embodiment, the set of word candidates are words appearing as the top-most requested search terms or spikes in particular search terms received by a search engine. At step 1240, the update module 950 monitors and tracks the usage of search terms in search requests on a per n-gram basis. For example, if the search term is “boston red sox,” the update module 950 can track the number of time a search request includes (i) unigrams—“boston” “red” and “sox,” (ii) bigrams “boston red” and “red sox,” and (iii) trigram “boston red sox.” At step 1242, the update module 950 identifies the top-most requested unigrams, bigrams, trigram, or other n-gram using a statistical analysis technique or detects spikes in the usage of particular unigrams, bigrams or trigrams in the search requests over a period of time. For example, after Oct. 27, 2005, the date on which Harriet Miers was nominated for a seat on the U.S. Supreme Court, the number of search requests including the name “Harriet Miers” increased dramatically. Such an event can trigger the search engine to check and update the language model and/or dictionary, as necessary. At step 1244, the update module 950 identifies word candidates from the list of identified search terms. For example, the set of word candidates can be limited to the top 20 search terms grouped according to unigrams, bigrams and trigrams. At step 1246, the set of word candidates are then processed by the update module 950 according to the method of FIG. 8B to update the speech recognition database 900.

Once the speech recognition database has been updated, any media file or stream that is subsequently processed by the speech recognition processor 100a can be more accurately converted to speech recognized text. However, the searchable index 40 is likely to maintain a large archive of enhanced metadata documents corresponding to media files or streams that were not processed using the updated dictionary 920, language model 930 or post-processing rules database 940. Using our previous example of “red sox” it is possible that, prior to the update to the language model, the speech recognition module 100a incorrectly recognized the term “red sox” as “red socks.” In most instances, it is inefficient and undesirable to reindex all previous media content. Thus, according to another aspect, the present invention features a method and apparatus for deciding which media content to reindex using the updated speech recognition database.

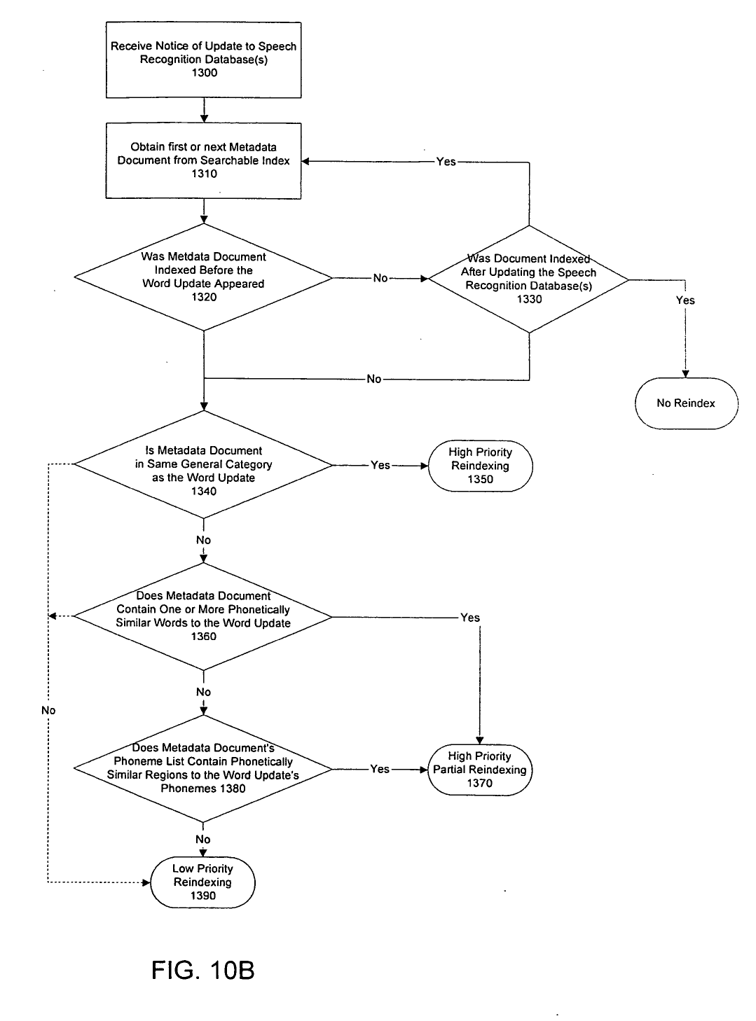

FIGS. 10A and 10B illustrate an apparatus and method, respectively, for scheduling media content for reindexing using an updated speech recognition database. As shown in FIG. 10A, the apparatus additionally includes a reindexing module 960 that interfaces with the update module 950, the media indexing controller 110 and the searchable index 40 as discussed with respect to FIG. 10B.

Referring to FIG. 10B, at step 1300, the reindexing module 960 receives a message, or other signal, which indicates that the speech recognition database 900 has been updated. Preferably, the message identifies the word candidates added to the speech recognition database 900 (“word update”), the date when each of the word update first appeared, and the date when the speech recognition database was updated. At step 1310, the reindexing module 960 communicates with the searchable index 40 to obtain a metadata document corresponding to a media file or stream, including an index of speech recognized text.

At step 1320, the reindexing module 960 determines whether the metadata document was indexed before one or more of the word updates appeared. For example, assume that a spike in the number of search requests including the term “Harriet Miers” first appeared on Oct. 27, 2005, the date when she was nominated for a seat on the U.S. Supreme Court. The date that the metadata document was indexed can be determined by a timestamp added to the document at the time of the earlier indexing. If the metadata document was indexed before the word update first appeared, the metadata document and its corresponding media file or stream are scheduled for reindexing according to a priority determined at step 1340. Conversely, if the metadata document was indexed after the word update first appeared, the reindexing module 960 determines at step 1330 whether the metadata document was indexed after the word update was added to the language model or dictionary.

If the metadata document was indexed after the update to the speech recognition database, there is no need to reindex the corresponding media file or stream and the reindexing module 960 returns to step 1310 to obtain the next metadata document. However, if the metadata document was indexed before the update to the speech recognition database, the reindexing module 960 schedules the document and corresponding media resource for reindexing according to a priority determined at step 1340.

At step 1340, the reindexing module 960 prioritizes scheduling by determining whether the contents of the media file or stream as suggested by the enhanced metadata document falls within the same general category as one or more of the newly added word update. As previously discussed, during the initial processing of the metadata, a natural language processor can be used to determine identify the topic boundaries within the audio stream. For instance, if the audio stream is a CNN (Cable Network News) podcast, the sequence of recognized words can be logically segmented into different topics being discussed (e.g. government, law, sports, weather, etc). To determine the context in which “Harriet Miers” is referenced, the top search results for “Harriet Miers” are downloaded and analyzed to determine the topic or context within which the word update Harriet Miers is referenced. Such downloads can also be used to identify related bigrams and trigrams to the search term that can be added to the language model or reweighted with updated confidence level if such terms are already incorporated within the models. For example, “Supreme Court” may be a likely bigram that would be identified in such an analysis.

If the topic identified by the enhanced metadata for a media file or stream falls within the same general category as the word update, the reindexing module 960 proceeds to step 1350 directing the media indexing controller 110 to reindex the metadata document with high priority according to FIG. 8B. Otherwise, if the topic of the media resource falls outside the general category, the reindexing module 960 can proceed to step 1390 directing the media indexing controller 110 to reindex the metadata document with low priority.

Optionally, if the topic of the media resource falls outside the general category, the reindexing module 960 can proceed through one or more steps 1360, 1370, 1380, and 1390. At step 1360, the reindexing module 960 determines whether the metadata document contains one or more phonetically similar words to the word update. According to a particular embodiment, this step can be accomplished by translating the word update and the words of the speech recognized text included in the metadata document into constituent sets of phonemes. Any technique for translating text to a constituent set of phonemes known to one skilled in the art can be used. After such translation, the reindexing module compares the phonemes of the word update with the translated phonemes for each word of the speech recognized text. If there is at least one speech recognized word having a constituent set of phonemes phonetically similar to that for the word update, then the reindexing module 960 can proceed to step 1370 for partial reindexing of the metadata document with high priority.

Such partial reindexing can include indexing a portion of the corresponding audio/video stream that includes the phonetically similar word using a technique such as that previously described in FIGS. 1A and 1B. The selected portion can be a specified duration of time about the phonetically similar word (e.g., 20 seconds) or a duration of time corresponding to an identified segment within the metadata document that contains the phonetically similar word, including those segments shown and described with respect to FIG. 2. The results of such partial reindexing is then merged back into the metadata document, such that the newly reindexed speech recognized text and its corresponding timing information replace the previous speech recognized text and timing information for that portion (e.g. selected time regions) of the audio/video stream. Conversely, if the metadata document does not contain one or more phonetically similar words to the word update, the reindexing module 960 can proceed to step 1390 for low priority reindexing.

Optionally, at step 1380, the reindexing module 960 determines whether the metadata document phoneme list contain phonetically similar regions to the phonemes of the word update. According to a particular embodiment, the metadata document additionally includes a list of phonemes identified by a speech recognition processor of the corresponding audio and/or video stream. The reindexing module compares contiguous sequences of phonemes from the list with the phonemes of the word update. If there is at least one sequence of phonemes that is phonetically similar to the phonemes of the word update, then the reindexing module 960 can proceed to step 1370 for partial reindexing of the metadata document with high priority as previously discussed. Otherwise, the reindexing module 960 proceeds to step 1390 for low priority reindexing.

Other criteria for prioritizing the scheduling of media content for reindexing can also be incorporated, such as determining likely topics of newly added words and processing older files of those topics first; determining likely words that may have been recognized previously and searching on those terms to prioritize; utilizing known existing documents coupled with top out-of-vocabulary search terms to augment the language models; using an underlying phonetic breakdown of a document coupled with the phonetic breakdown of the out-of-vocabulary search terms to determine which documents to re-index; prioritizing documents with named entities in the same entity class in the class of search term. In alternative embodiments, metadata documents can be reindexed without any determination of priority, such as first-in, first out (FIFO) basis.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (IC), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks. Communication networks can also all or a portion of the PSTN, for example, a portion owned by a specific carrier.

The computing system can include clients and servers. A client and server are generally remote from each other and typically interact through a communication network. The relationship of client and server arises by virtue of computer programs running on the respective computers and having a client-server relationship to each other.

While this invention has been particularly shown and described with references to preferred embodiments thereof, it will be understood by those skilled in the art that various changes in form and details may be made therein without departing from the scope of the invention encompassed by the appended claims.

What is claimed:

1. A method for reindexing media content for search applications, comprising:
providing a speech recognition database that include entries defining acoustical representations for a plurality of words;
providing a searchable database containing a plurality of metadata documents descriptive of a plurality of media resources, each of the plurality of metadata documents including a sequence of speech recognized text indexed using the speech recognition database;
updating the speech recognition database with at least one word candidate; and
reindexing the sequence of speech recognized text for a subset of the plurality of metadata documents using the updated speech recognition database, the subset of metadata documents including metadata documents having a sequence of speech recognized text generated before the speech recognition database was updated with the at least one word candidate.

2. The method of claim 1 further comprising:
obtaining the at least one word candidate from one or more sources; and
reindexing the sequence of speech recognized text for a subset of the plurality of metadata documents using the updated speech recognition database, the subset of metadata documents including metadata documents having a sequence of speech recognized text generated before the at least one word candidate was obtained from the one or more sources.

3. The method of claim 1 further comprising:
scheduling a media resource for reindexing using the updated speech recognition database with a high priority if the content of the media resource and the at least one word candidate are associated with a common category.

4. The method of claim 1 further comprising:
scheduling the media resource for reindexing using the updated speech recognition database with a low priority if the content of the media resource and the at least one word candidate are associated with different categories.

5. The method of claim 1 wherein updating the speech recognition database with at least one word includes adding an entry to the speech recognition database that maps the at least one word candidate to an acoustical representation.

6. The method of claim 5 wherein the entry is added to a dictionary of the speech recognition database.

7. The method of claim 5 wherein the entry is added to a language model of the speech recognition database.

8. The method of claim 1 wherein updating the speech recognition database with at least one word includes adding a rule to a post-processing rules database, the rule defining criteria for replacing one or more words in a sequence of speech recognized text with the at least one word candidate during a post processing step.

9. The method of claim 1 wherein each of the acoustical representations is a string of phonemes.

10. The method of claim 1 wherein the plurality of words includes individual words or multiple word strings.

11. The method of claim 1, further comprising:
obtaining metadata descriptive of a media resource, the metadata comprising a first address to a first web site that provides access to the media resource;
accessing the first web site using the first address to obtain data from the web site; and
selecting the at least one word candidate from the text of words collected or derived from the data obtained from the first web site; and
updating the speech recognition database with the at least one word candidate.

12. The method of claim 11 wherein the at least one word candidate includes one or more frequently occurring words from the data obtained from the first web site.

13. The method of claim 11 further comprising:
accessing the first web site to identify one or more related web sites, the related web sites being linked to or referenced by the first web site;
obtaining web page data from the one or more related web sites;
selecting the at least one word candidate from the text of words collected or derived from the web page data obtained from the related web sites; and
updating the speech recognition database with the at least one word candidate.

14. The method of claim 1 further comprising:
obtaining metadata descriptive of a media resource, the metadata includes descriptive text of the media resource;
selecting the at least one word candidate from the descriptive text of the metadata; and
updating the speech recognition database with the at least one word candidate.

15. The method of claim 14 wherein the descriptive text of the metadata comprises a title, description or a link to the media resource.

16. The method of claim 14 wherein the descriptive text of the metadata comprises information from a web page describing the media resource.

17. The method of claim 1, further comprising:
obtaining web page data from a selected set of web sites;
selecting the at least one word candidate from the text of words collected or derived from the web page data obtained from the related web sites; and
updating the speech recognition database with the at least one word candidate.

18. The method of claim 17 wherein the at least one word candidate includes one or more frequently occurring words from the data obtained from the selected set of web sites.

19. The method of claim 1 further comprising:
tracking a plurality of search requests received by a search engine, each search request including one or more search query terms; and
selecting the at least one word candidate from the one or more search query terms.

20. The method of claim 19 wherein the at least one word candidate includes one or more search terms comprising a set of topmost requested search terms.

21. The method of claim 1 further comprising:
generating an acoustical representation for the at least one word candidate, the acoustical representation being associated with a confidence score; and
updating the speech recognition database with the at least one word candidate, the at least one word having a confidence score that satisfies a predetermined threshold.

22. The method of claim 21 further comprising:
excluding the at least one word candidate from the speech recognition database, the at least one word having a confidence score that fails to satisfy a predetermined threshold.

23. The method of claim 1 wherein the plurality of media resources comprising an audio resource or a video resource.

24. The method of claim 23 wherein the plurality of media resource comprises an audio or video podcast.

25. The method of claim 1 wherein reindexing the sequence of speech recognized text comprises reindexing less than all of the speech recognized text.

26. The method of claim 1 wherein reindexing the sequence of speech recognized text comprises reindexing all of the speech recognized text.

27. The method of claim 1 further comprising:
scheduling a media resource for partial reindexing using the updated speech recognition database if the metadata document corresponding to the media resource contains one or more phonetically similar words to the at least one word candidate added to the speech recognition database.

28. The method of claim 1 wherein a metadata document further comprises a sequence of phonemes derived from a media resource further comprising:
scheduling the media resource for partial reindexing using the updated speech recognition database if the metadata document contains at least one phonetically similar region to the constituent phonemes of the at least one word candidate added to the speech recognition database.

29. An apparatus for reindexing media content for search applications, comprising:
a speech recognition database that includes entries defining acoustical representations for a plurality of words;
a searchable database containing a plurality of metadata documents descriptive of a plurality of media resources,
a media indexer that generates a sequence of speech recognized text included in each of the plurality of metadata documents using the speech recognition database;
an update module that updates the speech recognition database with at least one word candidate; and
a reindexing module that causes the media indexer to reindex the sequence of speech recognized text for a subset of the plurality of metadata documents using the updated speech recognition database, the subset of metadata documents including metadata documents having a sequence of speech recognized text generated before the speech recognition database was updated with the at least one word candidate.

30. An apparatus for reindexing media content for search applications, comprising:
means for providing a speech recognition database that include entries defining acoustical representations for a plurality of words;
means for providing a searchable database containing a plurality of metadata documents descriptive of a plurality of media resources, each of the plurality of metadata documents including a sequence of speech recognized text indexed using the speech recognition database;
means for updating the speech recognition database with at least one word candidate; and
means for reindexing the sequence of speech recognized text for a subset of the plurality of metadata documents using the updated speech recognition database, the subset of metadata documents including metadata documents having a sequence of speech recognized text generated before the speech recognition database was updated with the at least one word candidate.
